(19) United States
(12) Patent Application Publication
(10) Pub. No.: US 2026/0288943 A1
(43) Pub. Date: Sep. 24, 2026

(54) MEMORY DEVICE WITH SELF-PROTECTION AND SELF-PROTECTION METHOD

(71) Applicant: Elite Semiconductor Microelectronics Technology Inc., Hsinchu (TW)

(72) Inventor: Cheng-Hung Tsai, Hsinchu (TW)

(21) Appl. No.: 19/084,837

(22) Filed: Mar. 20, 2025

(51) Int. Cl. G06F 21/55

(52) U.S. Cl. CPC G06F 21/554; G06F 2221/034

(57) ABSTRACT

A memory device with self-protection includes a plurality of memory sections, a data line, and a controller. The controller issues an active command when a pending memory section among the plurality of memory sections is repeatedly accessed, wherein the pending memory section is surrounded by a preceding memory section and a following memory section; turns off the plurality of transistors to interrupt the data transmission between a first target memory section among the plurality of memory sections and the data line, wherein the first target memory section is the next one after the following memory section; and refreshes the data from the plurality of memory cells within a first target memory section among the plurality of memory sections according to the active command.

### BACKGROUND OF THE INVENTION

The disclosure relates to a memory device with self-protection and self-protection method. More specifically, the disclosure relates to a memory device with self-protection and a self-protection method which can provide timely protection for a DRAM by performing two types of refresh.

Conventional volatile memory devices (e.g., DRAM) have a multi-level structure, which includes ranks, chips, banks, and memory cells, each memory cell is used to store a piece of data. As shown in FIG. 1, a memory cell 100 within a memory section of a memory device is designed with a 6T layout includes at least two inverters (i.e., I1 and I2), three transistors (i.e., T1, T2, and T3), a capacitor (i.e., C1), and a bit switch BS for determining whether to transmit data, and a bitline BL (i.e., data line) for accessing data. In particular, such memory devices retain data only when powered on, therefore, when the power is turned off, the capacitors C1 will gradually lose its charge, causing the stored data to gradually be lost. Therefore, the memory device must periodically refresh all memory cell of the memory device to maintain data completeness (hereinafter referred to as “normal refresh”). In addition, to prevent hacker attacks on the memory device through Rowhammer (i.e., repeatedly accessing the same memory cell within a memory section of the memory device), which can cause data of the memory device loss or errors, the conventional memory device protection mechanisms are designed to issue a refresh command to sequentially refresh data of all memory cells when multiple accesses to the memory cell exceeds a threshold within a short period of time.

However, since the attacked memory sections is in an active state, and the unaccessed memory sections and accessed memory sections share the same data line, so if the normal refresh is performed on the unaccessed memory section, the data of the unaccessed and accessed memory sections will be transmitted to the data line, which can lead to data loss or errors. In other words, the memory device must pause the current normal refresh, and after the attack has ended, switch to refreshing the attacked memory section, and then continue the normal refresh. Therefore, the efficiency of conventional memory devices in preventing data loss or errors solely through normal refresh operations is limited.

In this case, the conventional memory devices must set up a large number of counters in each memory section to count the number of abnormal accesses to the memory cells, and a threshold with an appropriate access count must be set. When the access count exceeds this threshold, it is considered an attack. If the threshold is set too low, the memory device may frequently pause the current normal refresh and switch to refreshing the attacked memory section, which could affect the efficiency of the periodic normal refresh. Furthermore, the memory device must also record the location of the attacked memory section to ensure that the normal refresh can be performed. In view of this, it is important to overcome the problem in the art.

### SUMMARY OF THE INVENTION

To overcome at least the aforesaid problem, the present disclosure provides a memory device with self-protection. The memory device may include a plurality of memory sections, a data line, and a controller. The data line may be electrically connected with the plurality of memory sections separately, and the controller may be electrically connected with the plurality of memory sections and the data line. The plurality of memory sections may comprise a plurality of memory cells and a plurality of transistors, wherein the plurality of memory cells corresponding to the plurality of transistors respectively. The data line may be configured to transmit data of the plurality of memory sections. The controller may be configured to issue an active command when a pending memory section among the plurality of memory sections is repeatedly accessed, wherein the pending memory section is surrounded by a preceding memory section and a following memory section, turn off the plurality of transistors to interrupt the data transmission between a first target memory section among the plurality of memory sections and the data line when the pending memory section is repeatedly accessed, wherein the first target memory section is the next one after the following memory section; and refresh the data from the plurality of memory cells within the first target memory section according to the active command.

To overcome at least the aforesaid problem, the present disclosure also provides a self-protection method. The self-protection method may be used in a memory device, the memory device may comprise a plurality of memory sections, a data line, and a controller, each of the memory sections comprising a plurality of memory cells and a plurality of transistors, wherein the plurality of memory cells corresponding to the plurality of transistors respectively. The self-protection method may comprise steps of: issuing an active command when a pending memory section among the plurality of memory sections is repeatedly accessed, wherein the pending section is surrounded by a preceding memory section and a following memory section; turning off the plurality of transistors to interrupt the data transmission between the first target memory section and the data line when the pending memory section is repeatedly accessed, wherein the first target memory section is the next one after the following memory section; and refreshing the data from the plurality of memory cells within the first target memory section according to the active command.

The memory device protection mechanisms (including memory device with self-protection and self-protection method) provided by the present invention interrupts the data transmission between the memory cell and the data line by turning off the transistors corresponding to the memory cells within the memory section of the memory device when the same memory cell within a memory section is accessed continuously, this prevents the data of both the unaccessed memory sections and the accessed memory sections from being transmitted to the data line. Therefore, the present invention can employ two different types of refresh, that is, the data of the unaccessed memory cells can be refreshed according to active commands, while data of the accessed memory cells can be refreshed according to refresh normal commands, thereby reducing the overall time required to refresh the data of all memory cells.

The summary is not intended to limit the claimed invention, but merely provides basic profile of the claimed invention. The details of the claimed invention will be described with various embodiments as presented below.

### BRIEF DESCRIPTION OF DRAWINGS

FIG. 1 provides a conventional memory device protection mechanisms.

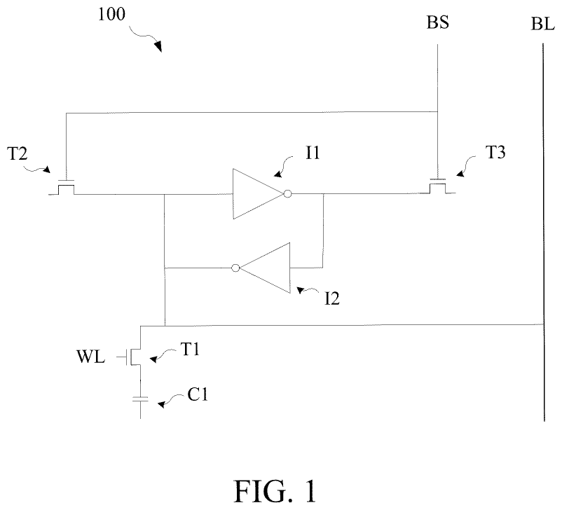

FIG. 2A provides a schematic view of a memory cell within a memory section of a memory device with self-protection according to some embodiments of the present invention.

FIG. 2B illustrates a refresh sequence of a plurality of memory sections of the proposed memory device according to some embodiments of the present invention.

FIG. 2C illustrates a table for showing the relationship between the refresh time and each memory section of the proposed memory device according to some embodiments of the present invention.

FIG. 3 illustrates a flowchart for describing a self-protection method according to some embodiments of the present invention.

### DETAILED DESCRIPTION OF THE INVENTION

The embodiments as disclosed below are not intended to limit the claimed invention to any specific environment, applications, structures, processes or situations. In the attached drawings, elements which are not directly related to the claimed invention are omitted from depiction. Dimensions and dimensional relationships among individual elements in the attached drawings are only exemplary examples and are not intended to limit the claimed invention. Unless stated particularly, same element numerals may correspond to same elements in the following description without inconsistency with the claimed invention.

The terminology used herein is for the purpose of describing the embodiments only and is not intended to limit the claimed invention. The singular forms “a” and “an” are intended to include the plural forms as well, unless the context clearly indicates otherwise. The terms “comprises,” “comprising,” “includes,” “including,” etc., specify the presence of the stated features, integers, operations, elements, and/or components, but do not preclude the presence or addition of one or more other features, integers, operations, elements, components, and/or groups thereof. The term “and/or” includes any and all combinations of one or more of the associated listed items. Although the terms “first” and “second” etc., may be used herein to describe various elements, these elements should not be limited by these terms. These terms are merely used to distinguish one element from another element. Thus, for example, a first element described below could also be termed a second element, without departing from the spirit and scope of the claimed invention.

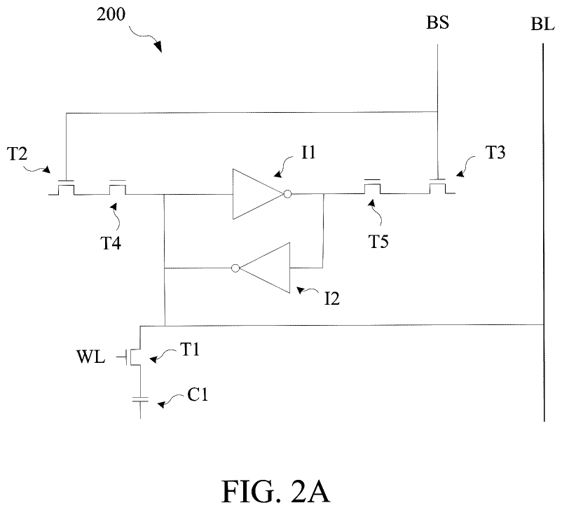

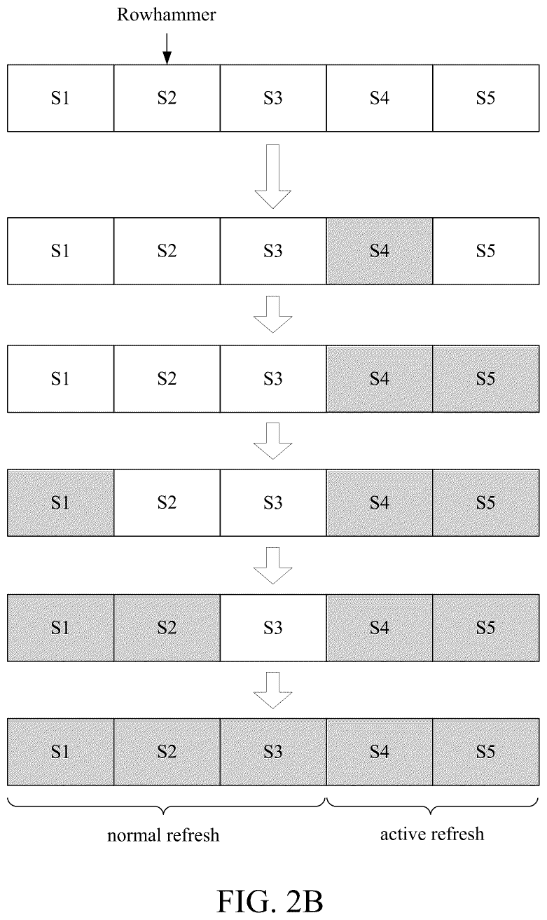

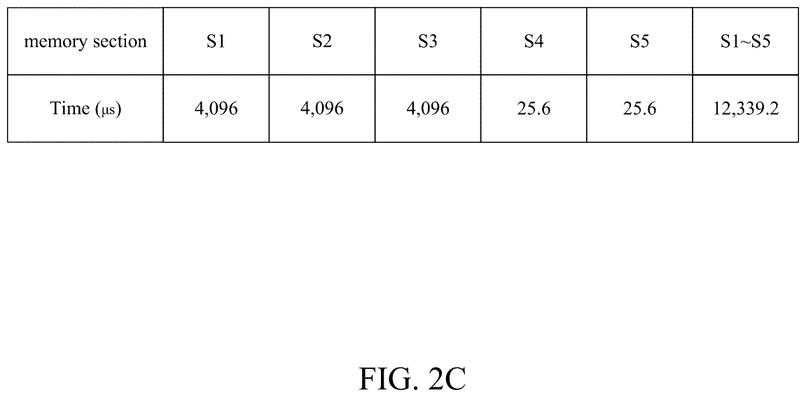

FIG. 2A illustrates a schematic view of a memory cell 200 within a memory section of a memory device with self-protection 1 (hereinafter referred to as “memory device 2”) according to some embodiments of the present invention, FIG. 2B illustrates the refresh sequence of the plurality of memory sections of the memory device 2 according to some embodiments of the present invention, and FIG. 2C illustrates a table for showing the relationship between the refresh time and each memory section of the memory device 2 according to some embodiments of the present invention. The contents shown in FIGS. 2A-2C are provided only for illustration and should not be construed as any limitations on the claimed invention.

As shown in FIG. 2A, the memory device 2 includes 5 memory sections (i.e., S1-S5), and each memory section includes 512 memory cells. The present invention does not limit the number of memory sections included in the memory device 2 or the number of memory cells included in the memory sections. In this embodiment, the memory cell 200 within a memory section of the memory device 2 is designed with an 8T layout and includes at least two inverters (i.e., I1 and I2), five transistors (i.e., T1, T2, T3, T4, and T5), and a capacitor (i.e., C1). It shall be appreciated that the memory device 2 also includes a controller (not shown), a sense amplifiers (not shown), a counter (not shown). In particular, the gate of the transistor T1 is connected to the wordline WL to control the conduction of the memory cell 200, the gates of the transistor T2 and the transistor T3 are connected to a bit switch BS to determine whether the data should be transmitted, and the drain of the transistor T1 is connected to a bitline BL (i.e., data line) to access the data stored in the memory cell 100. In addition, the memory device 2 may include a register, and only one register needs to be set up in each bank of the memory device 2 to record which memory section has been attacked.

In this embodiment, after the counter counts that the memory cell 200 of the memory section S2 of the memory device 2 is repeatedly accessed exceeding a threshold (e.g., 200 times), the controller determines an attack has occurred (i.e., Rowhammer). It should be noted that the threshold can be adjusted as needed and is not limited. Since the memory section S2 shares the same data line and sense amplifier with the memory section S1 and the memory section S3, the memory section S1 and the memory section S3 are also in an active state. Therefore, the controller will perform sequentially refreshing the data from the memory section S4.

Referring to FIG. 2B, for purposes of clarity, the refreshed memory sections are depicted in grayscale. In this specific example, taking a memory device 2 includes 5 memory sections (i.e., S1-S5) as an example, each memory section includes 512 memory cells. Therefore, the memory device 2 includes a total of 2,560 memory cells and it also connected to 2,560 wordlines WL. While the memory section S2 is being repeatedly accessed, the controller may issue an active command and turn off the transistor T4 and the transistor T5 to interrupt the data transmission between the memory section and the data line, and the controller also may sequentially refresh the data from the memory cell 200 in the memory section S4 according to the active command (known as “active refresh”), this prevents the data of both the memory section S4 and the memory section S1-S3 from being transmitted to the data line.

More specifically, the controller performs the active refresh to refresh the data from the memory cell 200 in the memory section S5, until the refresh the data of the memory section S5 (i.e., the next one where the memory section S1 is in the active state) is done. Next, the controller will then issue a refresh command and perform the normal refresh to sequentially refresh the data from the memory section S1 to the memory section S3, until all memory sections have been refreshed.

It should be noted that the time interval for normal refresh in the memory device 2 (i.e., tREFI (Refresh Interval Time)) is approximately 8 μs, and the shortest time from once active state to the next in the memory device 2 (i.e., tRC (Row Cycle Time)) is approximately 0.05 μs. As shown in FIG. 2C, since one memory section contains 512 memory cells, the controller requires only about 25.6 μs to perform the active refresh to refresh the data from all 512 memory cells within one memory section. In these circumstances, the controller requires about 51.2 μs to refresh the data from the memory sections S4-S5, and about 12,288 μs to perform the normal refresh to refresh the data from the memory sections S1-S3. Therefore, the controller requires only about 12339.2 μs to refresh the data from all memory cells within memory sections S1-S5. It is noted that the present invention does not limit which section the controller starts refreshing from. It also does not limit the order in which the sections are refreshed.

According to the above descriptions, when the memory sections of the memory device 2 is repeatedly accessed within a short period (i.e., Rowhammer), the memory device 2 can interrupt the data transmission between the memory sections and the data line through transistors T4 and T5. Thus, the memory device 2 can simultaneously perform the active refresh on the unaccessed memory sections during the Rowhammer. That is, memory device 2 does not need to pause the normal refresh operation and switch to refreshing the attacked memory section, as conventional memory devices do. Therefore, memory device 2 does not require a large number of counters to record abnormal access to the memory cells, nor does it need to set a high threshold for the number of accesses. Moreover, since the time required for active refresh is significantly shorter than that for normal refresh, memory device 2 achieves higher efficiency in preventing data loss or errors by combining active refresh with normal refresh.

In some embodiments, the memory device 2 may include 16 memory sections (i.e., S1-S16), and each memory section also includes 512 memory cells. The controller may perform sequentially refreshing data from the memory section S4 when the memory section S2 is repeatedly accessed, until the refresh the data of the memory section S16 (i.e., the next one where the memory section S1 is in the active state) is done, the controller will then issue a refresh command and perform normal refresh to sequentially refresh the data from the memory section S1 to the memory section S3, until all memory sections have been refreshed. In these circumstances, the controller requires about 332.8 μs to refresh the data from the memory sections S4-S16, and about 12,288 μs to perform the normal refresh to refresh the data from the memory sections S1-S3. Therefore, the controller requires only about 12620.8 μs to refresh the data from all memory cells within memory sections S1-S16.

In some embodiments, the transistor T5 may be disposed inside the memory cell 200 within the memory section of the memory device 2.

In some embodiments, the transistor T5 may be disposed outside the memory cell 200 within the memory section of the memory device 2 and electrically connected with the memory cell 200 and the data line. It is noted that descriptions related to this specific example is not intended to limit the scope of the present invention.

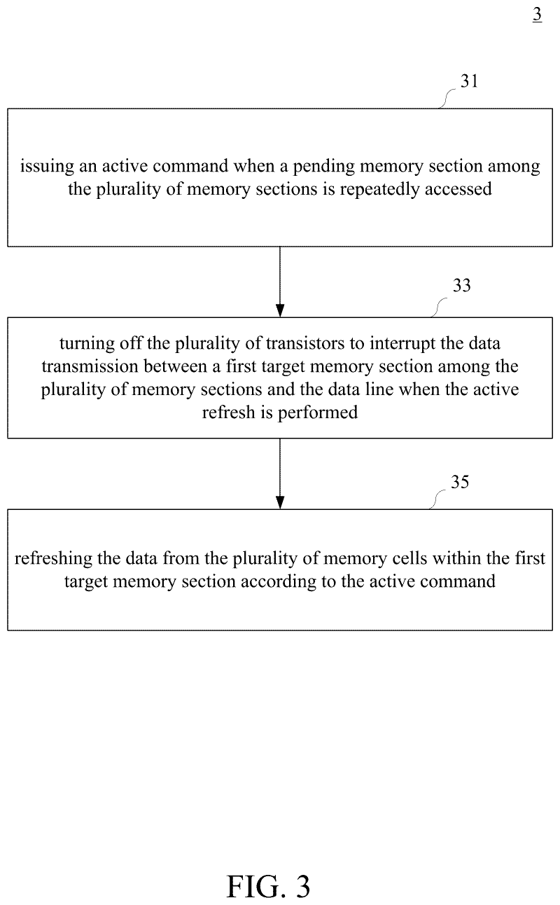

FIG. 3 illustrates a flowchart for describing a self-protection method according to some embodiments of the present invention. The contents shown in FIG. 3 is provided only for illustration and should not be construed as any limitations on the claimed invention.

As shown in FIG. 3, a self-protection method 3 is suitable for use in a memory device, e.g., the memory device 2 described in the first embodiment. In this embodiment, the memory device comprising a plurality of memory sections, a data line, and a controller, each of the memory sections comprising a plurality of memory cells and a plurality of transistors, wherein the plurality of memory cells corresponding to the plurality of transistors respectively. The self-protection method 3 may comprise the following steps: issuing an active command when a pending memory section among the plurality of memory sections is repeatedly accessed (marked as “31”), wherein the pending memory section is surrounded by a preceding memory section and a following memory section; turning off the plurality of transistors to interrupt the data transmission between the first target memory section and the data line when the pending memory section is repeatedly accessed (marked as “33”), wherein the first target memory section is the next one after the following memory section; and refreshing the data from the plurality of memory cells within the first target memory section according to the active command (marked as “35”).

In some embodiments, the self-protection method 3 may further include steps of: stopping the refresh of the data of the plurality of memory sections according to a refresh command before refreshing the data of the plurality of memory sections according to the active refresh.

In some embodiments, the self-protection method 3 may further include steps of: sequentially refreshing the data from the plurality of memory cells within the first target memory section to a last target memory section, wherein the next one after the last target memory section is the preceding memory section.

In some embodiments, the self-protection method 3 may further include steps of: issuing a refresh command when the refresh the data of the last target memory section is done; and refreshing the data from the plurality of memory cells within the preceding memory section according to the refresh command.

In some embodiments of the self-protection method 3, the one the plurality of transistors of the memory device is disposed inside the plurality of memory cells.

In some embodiments of the self-protection method 3, the one the plurality of transistors of the memory device is disposed outside the plurality of memory cells and electrically connected with the plurality of memory cells and the data line.

In some embodiments, the self-protection method 3 may further include steps of: counting the number of repeated accesses to the pending memory section; and refreshing the data from the plurality of memory cells within the first target memory section according to the active command when the number of repeated accesses exceeds a threshold value.

Each embodiment of the self-protection method 3 basically corresponds to a certain embodiment of the memory device 2. Therefore, people having ordinary skill in the art can fully understand and implement all the corresponding embodiments of the self-protection method 3 just by referring to the descriptions for the memory device 2, even though not all of the embodiments of the self-protection method 3 are described in detail above.

Without inconsistency with the claimed invention, a variety of combinations, modifications and/or replacements of the directly or indirectly disclosed embodiments are substantially included in the whole disclosure, even though they are not especially mentioned above. The scopes of the claimed invention are defined by the following claims as appended.

1. A memory device with self-protection, comprising:
a plurality of memory sections, each of the memory sections comprising a plurality of memory cells and a plurality of transistors, wherein the plurality of memory cells corresponding to the plurality of transistors respectively;
a data line, being electrically connected with the plurality of memory sections separately, and being configured to transmit data of the plurality of memory sections; and
a controller, being electrically connected with the plurality of memory sections and the data line, and being configured to:
issue an active command when a pending memory section among the plurality of memory sections is repeatedly accessed, wherein the pending memory section is surrounded by a preceding memory section and a following memory section;
turn off the plurality of transistors to interrupt the data transmission between a first target memory section among the plurality of memory sections and the data line when the pending memory section is repeatedly accessed, wherein the first target memory section is the next one after the following memory section; and
refresh the data from the plurality of memory cells within a first target memory section among the plurality of memory sections according to the active command.

2. The memory device of claim 1, wherein the controller is configured to stop refreshing the data of the plurality of memory sections according to a refresh command before refreshing the data of the plurality of memory sections according to the active command.

3. The memory device of claim 1, wherein the controller is configured to sequentially refresh the data from the plurality of memory cells within the first target memory section to the plurality of memory cells within a last target memory section, and wherein the next one after the last target memory section is the preceding memory section.

4. The memory device of claim 3, wherein the controller is configured to issue a refresh command when the refresh the data of the last target memory section is done, and refresh the data from the plurality of memory cells within the preceding memory section according to the refresh command.

5. The memory device of claim 1, wherein the plurality of transistors is disposed inside the plurality of memory cells.

6. The memory device of claim 1, wherein one of the plurality of transistors is disposed outside the plurality of memory cells and electrically connected with the plurality of memory cells and the data line.

7. The memory device of claim 1, further comprising a counter, being electrically connected with the plurality of memory sections and the controller, and being configured to count the number of repeated accesses to the pending memory section, wherein the controller refreshes the data from the plurality of memory cells within the first target memory section according to the active command when the number of repeated accesses exceeds a threshold value.

8. A self-protection method, being used in a memory device, the memory device comprising a plurality of memory sections, a data line, and a controller, each of the memory sections comprising a plurality of memory cells and a plurality of transistors, wherein the plurality of memory cells corresponding to the plurality of transistors respectively, the self-protection method comprising:
issuing an active command when a pending memory section among the plurality of memory sections is repeatedly accessed, wherein the pending memory section is surrounded by a preceding memory section and a following memory section;
turning off the plurality of transistors to interrupt data transmission between a first target memory section among the plurality of memory sections and the data line when the pending memory section among the plurality of memory sections is repeatedly accessed, wherein the first target memory section is the next one after the second adjacent memory section; and
refresh the data from the plurality of memory cells within the first target memory section according to the active command.

9. The self-protection method of claim 8, further comprising:
stopping the refresh of the data of the plurality of memory sections according to a normal refresh command before refreshing the data of the plurality of memory sections according to the active command.

10. The self-protection method of claim 8, further comprising:
sequentially refreshing the data from the plurality of memory cells within the first target memory section to a last target memory section, wherein the next one after the last target memory section is the preceding adjacent memory section.

11. The self-protection method of claim 10, further comprising:
issuing a refresh command when the refresh the data of the last target memory section is done; and
refreshing the data from the plurality of memory cells within the preceding memory section according to the refresh command.

12. The self-protection method of claim 8, wherein the plurality of transistors is disposed inside the plurality of memory cells.

13. The self-protection method of claim 8, wherein one the plurality of transistors is disposed outside the plurality of memory cells and electrically connected with the plurality of memory cells and the data line.

14. The self-protection method of claim 8, further comprising:
counting the number of repeated accesses to the pending memory section; and
refreshing the data from the plurality of memory cells within the first target memory section according to the active command when the number of repeated accesses exceeds a threshold value.
